(19) United States
(12) Patent Application Publication
(10) Pub. No.: US 2005/0019656 A1
(43) Pub. Date: Jan. 27, 2005

(54) Method for fabricating composite electrodes

(76) Inventors: Sang Young Yoon, Saugus, CA (US); Bookeun Ph, Lisle, IL (US); Khalil Amine, Grove, IL (US)

Correspondence Address: M Elizabeth Bush;Quallion, P O Box 923127, Sylmar, CA, 91392-3127, US

(21) Appl. No.: 10/496,231

(22) PCT Filed: Mar. 20, 2003
(86) PCT No.: PCT/US03/08783

Related U.S. Application Data
(63) Continuation-in-part of application No. 10/104,352, filed on Mar. 22, 2002.
(60) Provisional application No. 60/451,065, filed on Feb. 26, 2003.
(60) Provisional application No. 60/443,892, filed on Jan. 30, 2003.
(60) Provisional application No. 60/446,848, filed on Feb. 11, 2003.

(30) Foreign Application Priority Data
Jan. 22, 2003 (WO) PCT/US03/02127
Jan. 22, 2003 (WO) PCT/US03/02128

(51) Int. Cl. H01M 4/04; H01M 4/62; H01M 4/52

(52) U.S. Cl. 429/217; 141/1.1; 429/231.95; 429/231.6; 429/231.3; 429/231.1; 429/223; 29/623.5; 29/623.2

(57) ABSTRACT

Disclosed is a method for manufacturing electrodes (100) for electrochemical devices such as batteries and capacitors in which a viscous polysiloxane polymer electrolyte (116) is incorporated into the slurry of materials forming the electrode (100). The optional addition of protective additives (218) to the slurry is also disclosed. A follow-on vacuum impregnation step (228) is disclosed to further improve penetration and wetting by the electrolyte (116).

### REFERENCE TO PRIOR FILED APPLICATIONS

This application claims priority to copending provisional application Ser. No. 60/451,065 entitled “Method for Fabricating Composite Electrodes” filed Feb. 26, 2003; and to copending provisional application Ser. No. 60/443,892 entitled “Nonaqueous Liquid Electrolyte” filed Jan. 30, 2003; and to copending provisional application Ser. No. 60/446,848 entitled “Polymer Electrolyte for Electrochemical Cell” filed Feb. 11, 2002; and to PCT/US03/02127, filed Jan. 22, 2003; and to PCT/US03/02128, filed Jan. 22, 2003; and to copending U.S. application Ser. No. 10/167,490 filed Jun. 12, 2002, which is a Continuation-in-Part of co-pending application Ser. No. 10/104,352, filed Mar. 22, 2002, the disclosure of each of which is incorporated herein in its entirety by reference, including all disclosures submitted therewith.

### STATEMENT REGARDING FEDERALLY SPONSORED RESEARCH OR DEVELOPMENT

This invention was made with United States Government support under NIST ATP Award No. 70NANB043022 awarded by the National Institute of Standards and Technology (NIST). The United States Government has certain rights in this invention pursuant to NIST ATP Award No. 70NANB043022 and pursuant to Contract No. W-31-109-ENG-38 between the United States Government and the University of Chicago representing Argonne National Laboratory.

### FIELD

The present invention relates to fabrication methods for polymer batteries using liquid polymer electrolytes. More particularly, the present invention relates to a method to improve the performance of liquid electrolyte alkali metal polymer batteries (especially, lithium metal and lithium ion) including, rate, capacity, and cycle life. As used herein, “lithium battery” or “lithium ion battery” shall be defined as including batteries made with any alkali metals or alkaline earth metals whether or not a metal electrode is used.

### BACKGROUND

The demand for the application of polymeric electrolytes has increased because of their impact on calendar life and safety of batteries. Conventional electrolytes with nonaqueous carbonate solvents and lithium hexafluorophosphate salts react violently with positive and negative electrodes in lithium ion batteries resulting in significant loss in calendar life and raising safety concerns. Therefore, the development of conductive liquid polymers that are nonvolatile and are resistive to oxidation and reduction could lead to new lithium ion polymer battery systems with long calendar life and improved safety performance. Electrolytes based on polymeric structures generally have better heat resistance than conventional carbonate based electrolytes. Although the electrolytes with polymeric structure have numerous advantages over the carbonate solvent based electrolytes, their application in lithium ion secondary batteries has been limited due to low ionic conductivity, usually below 10⁻⁴ S/cm at room temperature. Up to now, most liquid polymers such as siloxane or phosphorous hetero-polymers have very high viscosity and cannot be used in lithium ion batteries because of difficulty in effectively wetting the electrodes.

Polymer lithium batteries offer substantial advantages over lithium batteries with currently-known liquid electrolytes. Among these advantages are enhanced safety, long cycle life, high energy density, and flexibility. Polymer lithium batteries also hold great promise to be manufactured with ease, since thin film processes in the polymer industry can be used or adapted to the production of secondary lithium ion batteries.

One of the key issues in commercializing secondary lithium ion polymer batteries is the ionic conductivity of polymer electrolyte, which is essential for high rate operation of the lithium battery. Some polymeric electrolyte solutions can be applied to the electrolyte filling process in lithium ion secondary battery manufacture in the same way as the other electrolytes such as carbonate-based solutions. Lithium ion secondary batteries with the polymer as a conducting medium can be fabricated by injecting the polymeric electrolyte solution into a spiral jelly roll type cell or a stacked cell. It can also be coated onto the surface of electrodes and assembled with a porous separator to fabricate single or multi-stacked cells that are packaged within a plastic or plastic-coated aluminum type pouch. These techniques are well-known in the art; however, they are not suitable for viscous polymers such as siloxanes and phosphorous hetero-polymers because of their high viscosity.

In general, most liquid polymer electrolytes are more thermally stable and less volatile than low molecular weight chemicals such as carbonates. Therefore, the present inventors have investigated the wetting and penetration mechanism of viscous liquid polymer electrolytes and have developed a new electrode manufacturing process that incorporates the liquid polymer during the fabrication of the electrodes. The liquid polymer electrolytes used in the composite electrodes have beneficial characteristics such as high conductivity and stability at higher temperatures than are used for drying the solvent used to mix the binder.

The demand for a safer lithium battery for high power and high energy applications has led to substantial research and development activities in flame-retardant, solid polymer electrolyte and new concept electrolytes with improved thermostability. In addition, the increasing need for safe power sources for medical applications such as implanted batteries demands new approaches to manufacturing batteries that result in high reliability and safety without sacrificing capacity and rate capability.

To meet this demand, new nonvolatile, liquid polymeric electrolytes were developed. Electrolytes based on polymeric structure have fundamentally better heat resistance than conventional carbonate based electrolytes and can reduce many side chemical reactions occurring in lithium secondary battery under abnormal operating conditions such as temperatures exceeding 60° C. The present inventors have developed liquid polymer electrolytes that do not evaporate at temperatures up to 150° C., offer high ionic conductivity around room temperature, and have a wide electrochemical stability window. However, the high viscosity of these new polymer electrolytes inhibits effective penetration and wetting of electrode materials. Therefore, a need was seen to develop a new method to effectively manufacture batteries with viscous polymer electrolytes such as polysiloxane electrolytes.

### BRIEF SUMMARY

The aim of this invention was to develop an engineering and manufacturing process that overcomes the problem of the viscous liquid polymers and permits the polymers not only to wet, but also to effectively penetrate the bulk of the electrode.

The present invention incorporates the polymer electrolyte mixed with the salt and conductive agent (e.g., acetylene black, natural graphite, artificial graphite, graphite whiskers, graphite fibers, metal whisker, metal fibers, etc.) in a slurry that contains the active material. The slurry may also contain a binder and/or a solvent (e.g., N-methylpyrrolidone (NMP), acetonitrile, or water) to adjust the casting viscosity. The slurry is then cast on or around the current collector and dried at temperatures around 120° C. This forms an electrode with much lower porosity than that in conventional lithium ion batteries. Preferably, the pore volume is equal to that of the volume of the solvent such as NMP used in dissolving the binder. Protective additives may also be incorporated. These additives form a passivation film (solid-electrolyte interface (SEI)), on the negative electrode and may suppress gas evolution. Such additives may be incorporated into the electrolyte. Accordingly, the invention is a new fabrication method in which the electrode contains at least some of the polymer electrolyte when it is formed. These electrodes are highly suitable for electrochemical devices such as lithium batteries and capacitors. Additional penetration and wetting of the electrodes may be carried out after formation by the use of vacuum impregnation.

An object of the present invention is to provide a composite electrode structure, with improved capacity, cycling, and manufacturability.

A further object of the present invention is to provide a method of manufacture which is easily applied to the lithium ion electrode technology.

Yet a further object of the present invention is to provide an improved fabrication method for electrodes, especially for use in consumer products, electric and hybrid-electric vehicles, submarines, medical and satellite applications.

### BRIEF DESCRIPTION OF THE DRAWINGS

FIG. 1 is a schematic of the composite electrode made according to the present invention.

FIG. 2 is a flow chart of the fabrication process for an electrode made according to the present invention.

FIG. 3 shows charge (Li de-intercalation) curves for three composite negative electrodes made according to the present invention.

FIG. 4 shows charge (Li de-intercalation) curves of composite electrodes made according to the present invention.

FIG. 5 is a cycling capacity graph for several composite electrodes made according to the present invention.

### DETAILED DESCRIPTION

Table 1 summarizes experiments carried out with the purpose of cycling the electrode when using different methods of incorporating the polymer in the electrodes. As can be seen, all the processes of electrolyte filling (after casting of the electrode) were unsuccessful due to the high viscosity of the electrolyte and its inability to penetrate the electrode material.

TABLE 1
Capacity of carbon materials and processes used for polymer
electrolyte filling carbon-lithium metal cells.

| | | Capacity |
|---|---|---|
| Method | Description | (mAh/g) |
| Standard | Same as lithium ion coin cell | 1.6 |
| Vacuum | Dip electrode into sioxane-PEO electrolyte | 91.8 |
| treatment | and put it in vacuum for 20 min | |
| Standard + | Use standard method for cell assembly | 5.0 |
| High Temp. | and 70° C., C/14 formation | |
| formation | | |
| Dilution with | Dilute polysiloxane liquid* electrolyte with | |
| conventional | 1.2-M LiPF₆ in EC:EMC(3:7) | |
| liquid | and use standard method to assemble cell | |
| electrolyte | | |
| & Standard | | |
| | 5% siloxane | 143.0 |
| | 50% siloxane | 102.0 |
| | 80% siloxane | 35.6 |

*PMHS3B = 3 oxygens, on side chain, no spacer:

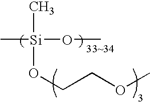

To solve these major wetting and electrolyte penetration problems in the electrodes, a new manufacturing concept for the electrode fabrication is needed. The present inventors developed a process for mixing the polymer electrolyte directly with the active materials and binder during the process of slurry making. This process allows for an intimate mix of the polymer with the active material providing lithium ion conductive network needed for cycling the electrodes. The liquid type polymeric electrolytes should be composed of nonvolatile compounds. In the case of lithium ion batteries, the amount of polymer during the mixing process should be equal to or greater than the volume of electrode. The electrode should contain about 20% to 60% pores.

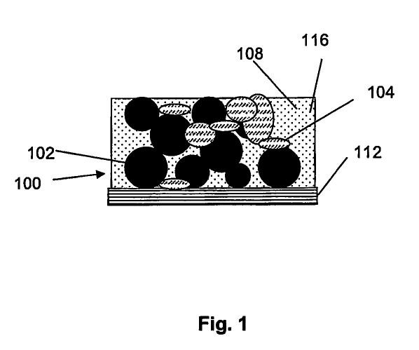

FIG. 1 shows a schematic of composite electrode 100, which contains a positive or negative active material 102, conducting agent 104 (carbon black, graphite powder, and mixtures thereof), polymer binder (such as poly(vinylidene fluoride) (PVDF), styrene-butadiene rubber (SBR), acrylate binder, other rubber binders, and mixtures thereof) 108, current collector 112, and the liquid type polymeric electrolyte 116. The polymer electrolyte 116 is an integral part of the electrode. The density of composite electrode is preferably about 1.2-3.0 g/cc, but may be as high as about 8.0 g/cc.

The proposed composite electrode structure and its processing method yield high charge/discharge characteristics. A follow-on vacuum impregnation process after forming the composite electrode (containing polymer electrolyte) was effective in further improving the charge/discharge characteristics.

The polymeric electrolyte 116 is preferably a polysiloxane liquid. Its structure may take a variety of forms, including, but not limited to, any of the following, with or without propylene spacers between the Si atom of main chains and any PEO side chain. 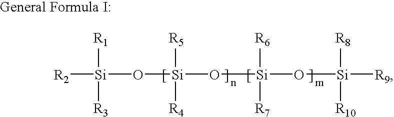
wherein, R₁, R₂, R₃, R₇, R₈, R₉ and R₁₀ are alkyl groups, preferably chosen from methyl, ethyl, propyl, and butyl; at least one of —R₄ and —R₅ is represented by General Formula II; R₆ is an alkyl group preferably chosen from methyl, ethyl, propyl and butyl or represented by General Formula m; n is equal to 3 to 200, m is equal to 0 to 200; 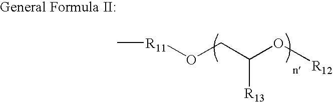
wherein, R₁₁ is nil or is an alkylene, preferably trimethylene, R₁₂ is alkyl group, preferably chosen from methyl, ethyl, propyl, and butyl, R₁₃ is hydrogen or an alkyl group, n′ is less than about 20; 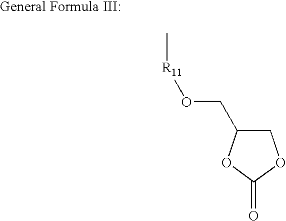
wherein, R₁₁ is nil or is an alkylene, preferably trimethylene. 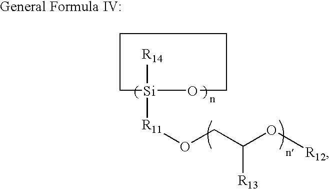
wherein, R₁₁ is nil or is an alkylene, preferably trimethylene, R₁₂ is an alkyl group, preferably chosen from methyl, ethyl, propyl, and butyl, R₁₃ is hydrogen or an alkyl group, n is equal to 3 to 10, n′ is less than about 20. 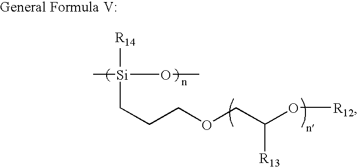
wherein, R₁₂ and R₁₄ are alkyl groups, preferably chosen from methyl, ethyl, propyl, and butyl, R₁₃ is hydrogen or an alkyl group, n is equal to 3 to 200, n′ is less than about 20.

General Formula V is considered the preferred structure. This molecule can be synthesized through hydrosylilation between polysiloxane containing Si—H bond and allyl terminated polyethylene glycol methyl ether.

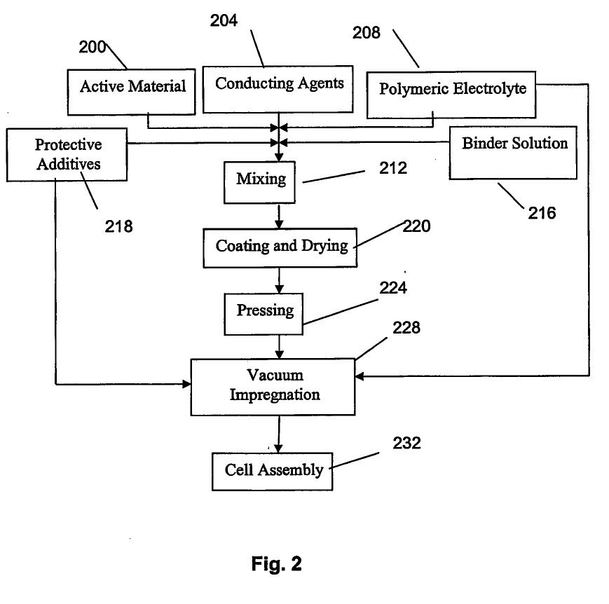

FIG. 2 is a flow chart showing the steps of the fabrication process of composite electrodes and the cell. The process is similar to that traditionally used in lithium ion technology except for adding liquid polymer electrolyte to the slurry before the coating process and formation of electrodes. Therefore, this process is easy to implement for the mass production of electrodes. Specifically, active material 200, conducting agents 204 (e.g., graphite), and polymeric electrolyte 208 (e.g., poly(siloxane-g-ethylene oxide)) are mixed 212 with a binder solution 216 (e.g., PVDF, styrene butadiene rubber (SBR), acrylate binder, acrylonitrile/butadiene rubber (NBR), isoprene, and natural rubber) and one or more protective additives 218. The resulting mixture is coated and dried 220 (onto a current collector and pressed 224. Next, the formed electrode is vacuum impregnated 228 with additional liquid polymer electrolyte 208 and, optionally, protective additives 218, to assure maximum penetration and wetting. Finally, the cells are assembled 232 into batteries according to conventional methods such as winding or stacking/laminating. Active materials may be any known material or combination of known materials such as LiCoO₂, LiNiO₂, LiNi₁₋ₓCo_{y}Me_{z}O₂ (where Me is Mg, Ti, Zn, or Al), LiMn_{0.5}Ni_{0.5}O₂, LiMn_{0.3}Co_{0.3}Ni_{0.3}O₂, LiFePO₄, LiMn₂O₄, LiFeO₂, LiMn_{1.5}MeO₄ (where Me is Ni, Co, or Fe), or combinations thereof The active material used is not limited as the present process is applicable to any such material now-known, insubstantially different from those now-known, or currently unforeseeable active materials which might be developed in the future.

Protective additives 218 may include any additives that decompose at voltages higher than 0.6 V and form a passivation film (SEI film) on the negative electrode. These include, but are not limited to, vinyl ethylene carbonate (VEC), vinylene carbonate (VC), ethylene carbonate (EC), and propylene carbonate (PC). Protective additives 218 may also include additives that suppress the gas evolution at the negative electrode, such as ethylene sulfide (ES) and ethylene ethyl phosphate (EEP). See, e.g., U.S. Pat. No. 5,753,389 to Gan et al. (assigned to Wilson Greatbatch Ltd.); Aurbach et al., J. Electrochem. Soc., 143, 3809 (1996).

The additives are mixed with the liquid polymeric electrolyte and may be incorporated by the electrolyte vacuum impregnation process. Such protective additives will suppress the evolved gas generated by the decomposition of SEI film and will improve cycling performance. Protective additives should preferably comprise no more than 50 wt % of the total electrolyte.

The following example describes the manner and process of making a composite electrode and its cell according to the present invention.

A negative composite electrode mixture of 74% by weight of the graphite powder (GDR) and 18 wt % of polysiloxane/LiTFSi binder electrolyte was prepared. In addition, 8 wt % polyvinylidene fluoride (PVDF) was added as a binder to the composite mixture. The PVDF was dispersed into N-methylpyrrolidone to form a slurry or paste. The mixture of negative composite electrode was homogeneously mixed by ball milling for 12 hrs. The slurry was coated onto one face of a copper foil strip having a thickness of 20 μm as a negative electrode current collector, was dried at 80° C. in vacuum overnight, and was subjected to the roll press to form a strip negative electrode having a thickness of 65 μm. A graphite electrode was punched out to form a negative electrode with 15 mm diameter, and then electrolyte was impregnated into the electrode in a vacuum over night.

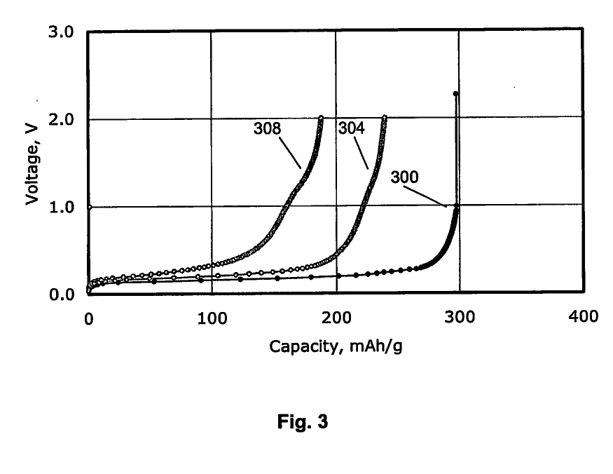

FIG. 3 shows the effect of vacuum impregnation of siloxane polymer and electrode density on the charge/discharge characteristics. It may be seen that it is most effective to impregnate the electrodes with the liquid siloxane polymer electrolyte under a vacuum. Trace 300 represents the discharge cycle curve for a cell made with vacuum-impregnated electrodes with a density of 1.3 g/cc. This sample exhibited a capacity of about 300 mAh/g. Trace 304 shows the discharge cycle curve for a cell having vacuum-impregnated electrodes having 1.8 g/cc density. It had approximately 240 mAh/g capacity. Trace 308 is the discharge cycle for a cell with 1.8 g/cc density electrodes that were not vacuum-impregnated. This cell exhibited a capacity of only about 180 mAh/g, significantly less than either of the vacuum-impregnated cells tested. Electrodes were prepared by 74% GDR graphite powder, 8% PVDF binder with 18% 1-M LiTFSi/siloxane polymer electrolyte in NMP organic solvent. The mixture was coated onto copper foil, and dried under a vacuum. The electrodes were then tested in a 2016 coin cell. Lithium metal was used for the counter electrode with 1-M LiTFSi/siloxane polymer electrolyte. All the cells were tested at the C/20 rate.

In the present invention, a second solvent may be added as a protective additive to the liquid polymeric electrolyte, in order to improve the wettability of negative electrode, to form the SEI film on the graphite surface, and to suppress further decomposition of liquid siloxane polymer. Examples of preferred additives are EC, PC, and VEC. A coin-shaped test cell having a diameter of 20 mm and a thickness of 1.6 mm was prepared. The cell was made up of a counter electrode/Li metal; separator/porous film formed of polypropylene; electrolyte/solution obtained by dissolving LiTFSi in a liquid polysiloxane polymer; MCMB graphite composite electrode/current collector/copper foil. A separator was used as a microporous polypropylene film having a thickness of 25 μm.

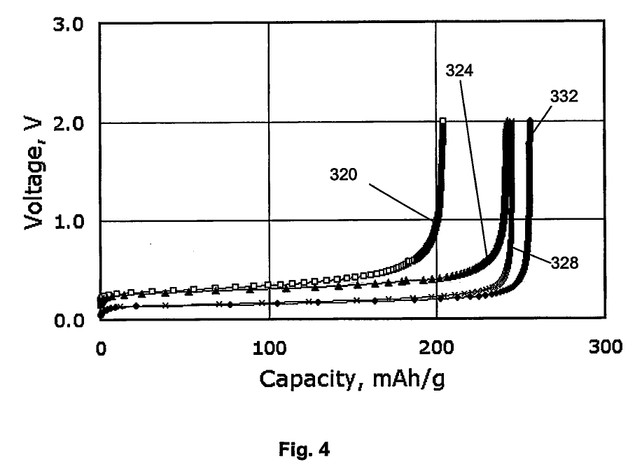

FIG. 4 shows the capacity characteristics of Li metal/MCMB graphite composite electrode cell comprising polysiloxane liquid polymer/lithium bis(oxalato) borate (“LiBoB”) electrolyte containing 3% organic additive. The composition of MCMB composite was exactly same as that of above-mentioned GDR composite electrodes. Additional electrolyte was filled in by vacuum impregnation. Curve 320 shows the performance with no protective additives. Cells made with VEC, PC, and EC are shown by curves 324, 328 and 332 respectively. It may be seen that the addition of protective additives increased capacity versus the cell with no additives from just above 200 mAh/g to a range of 240 to 260 mAh/g, representing a minimum of 20% increase in capacity.

It is believed that capacity was increased by the supplementation of additional organic solvents because the organic additives worked as wetting agents to decrease the viscosity of electrolyte and thus improve the wetting of the graphite electrode. Such additional solvents can also improve cycling performance at high rates.

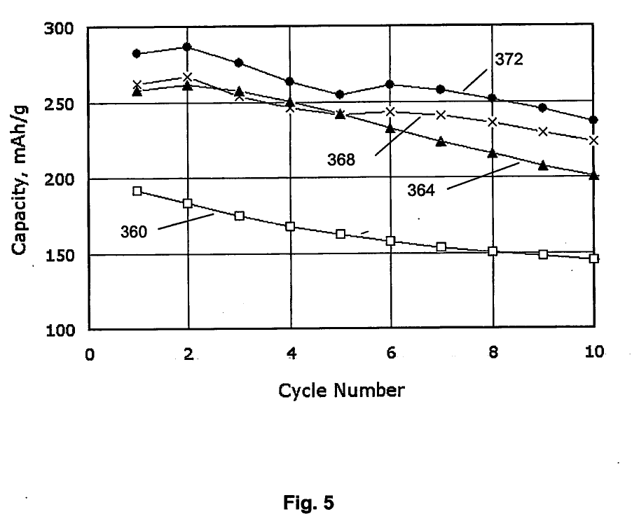

FIG. 5 presents the cycling performance of the same type cells as in FIG. 3. The cycling performance of the cell made with no additional protective solvents is shown by curve 360. The greatly improved performance by the addition of VEC, PC, and EC is shown by curves 364, 368, and 372, respectively. The cell with no additives 360 showed less than 150 mAh/g capacity after 10 cycles, while the cells with protective additive ranged from 200 to 240 mAh/g after 10 cycles.

It is believed that the organic additives of the present invention are reduced to form an SEI film which deposits on the graphite anode surface. This surface SEI film is electrochemically more stable and ionically more conductive than the SEI film formed in the absence of the organic additives. Thus, the surface SEI film so formed is believed responsible for improved cell performance.

The specific implementations disclosed above are by way of example and for the purpose of enabling persons skilled in the art to implement the invention only. We have made every effort to describe all the embodiments we have foreseen. There may be embodiments that are unforeseeable or which are insubstantially different. We have further made every effort to describe the invention, including the best mode of practicing it. Any omission of any variation of the invention disclosed is not intended to dedicate such variation to the public, and all unforeseen or insubstantial variations are intended to be covered by the claims appended hereto. Accordingly, the invention is not to be limited except by the appended claims and legal equivalents.

1-31. (cancelled)

32. A method for making a composite electrode comprising the acts of:
a) mixing to form a slurry at least one of each of the following: active material and liquid polymer; and
b) casting said slurry in contact with at least one current collector.

33. The method recited in claim 32 wherein said at least one active material is selected from the group consisting of: LiCoO₂, LiNiO₂, LiNi₁₋ₓCo_{y}Me_{z}O₂ (Me: Mg, Ti, Zn, Al), LiMn_{0.5}Ni_{0.5}O₂, LiMn_{0.3}Co_{0.3}Ni_{0.3}O₂, LiFePO₄, LiMn₂O₄, LiFeO₂, and LiMn_{1.5}MeO₄ (Me: Ni, co, fe):

34. The method recited in claim 32 wherein said at least one active material comprises one or more negative active materials selected from the group consisting of: graphite, carbon, Li₄Ti₅O₁₂, tin alloys, and intermetallic compounds.

35. The method recited in claim 32 wherein said liquid polymer comprises a saturated liquid polymer.

36. The method recited in claim 32 wherein said liquid polymer is a polysiloxane liquid.

37. The method recited in claim 32 wherein said liquid polymer comprises poly(siloxane-g-ethylene oxide).

38. The method recited in claim 32 wherein said liquid polymer comprises side chains with polyethylene oxide moieties.

39. The method recited in claim 32 wherein the ratio of in said liquid polymer is about 5 to 50.

40. The method recited in claim 32 wherein said act of mixing further comprises mixing a salt so that said salt and said liquid polymer form a liquid polymeric electrolyte, and wherein said liquid polymeric electrolyte is a conductor of metal ions selected from the group consisting of: alkali metals and alkaline earth metals.

41. The method recited in claim 32 wherein said act of mixing further comprises mixing a salt chosen from the group consisting of LiBOB and LiTFSi.

42. The method recited in claim 32 wherein said act of mixing further comprises mixing a solvent.

43. The method recited in claim 42 wherein said solvent comprises one or more materials selected from the group consisting of: N-methylpyrrolidone (NMP), dimethyl formamide, dimethyl acetamide, tetrahydrofuran, acetonitrile, and water.

44. The method recited in claim 32 wherein said act of mixing further comprises mixing a binder.

45. The method recited in claim 44 wherein said binder comprises at least one material selected from the group consisting of: PVDF, styrene-butadiene rubber (SBR), acrylate binder, acrylonitrile/butadiene rubber (NBR), isoprene, natural rubber, and other rubber binders.

46. The method recited in claim 45 wherein said binder comprises less than 50 wt % of said composite electrode.

47. The method recited in claim 32 wherein said act of mixing further comprises mixing a conductive agent comprising one or more materials selected from the group consisting of: acetylene black, natural graphite, artificial graphite, graphite whiskers, graphite fibers, metal whiskers, and metal fibers.

48. The method recited in claim 32 wherein said act of mixing further comprises mixing at least one protective additive.

49. The method recited in claim 48 wherein said at least one protective additive comprises one or more materials that decompose at voltages higher that 0.6 V and form a passivation film on the negative electrode.

50. The method recited in claim 49 wherein said at least one protective additive is selected from the group consisting of vinyl ethylene carbonate (VEC), vinylene carbonate (VC), ethylene carbonate (EC), propylene carbonate (PC), sulfur dioxide (SO₂), ethylene sulfide (ES), and ethylene ethyl phosphate (EEP).

51. The method recited in claim 48 wherein said protective additive comprises less than 50 wt % of the total electrolyte.

52. The method recited in claim 32 further including the act of drying said slurry.

53. A composite electrode made according to the method recited in claim 32.

54. The composite electrode recited in claim 53 wherein the density of said electrode is less than or equal to about 8.0 g/cc.

55. The composite electrode recited in claim 53 wherein the density of said electrode is less than or equal to about 3.0g/cc.

56. The composite electrode recited in claim 53 wherein the density of said electrode is about 1.2 to 3.0g/cc.

57. A composite electrode made according to the method recited in claim 40.

58. The composite electrode recited in claim 57 wherein said metal is lithium.

59. An electrochemical device comprising at least one electrode made according to the method recited in claim 32.

60. A method for making an electrochemical device comprising the acts of:
a) providing a positive composite electrode made according to the method recited in claim 32;
b) providing a porous separator;
c) providing a negative composite electrode made according to the method recited in claim 32;
d) placing said porous separator between said positive electrode and said negative electrode;
e) placing the combination of said positive electrode, said porous separator, and said negative electrode in a container;
f) vacuum impregnating said electrodes with metal ion conducting liquid polymeric electrolyte; and
g) sealing said container.

61. The method recited in claim 60 wherein said liquid polymer of at least one of said electrodes is a polysiloxane liquid.

62. The method recited in claim 60 wherein said vacuum impregnating act comprises vacuum impregnating said electrodes with metal ion conducting liquid polymeric electrolyte wherein said metal ion is selected from the group consisting of: alkali metals and alkaline earth metals.

63. The method recited in claim 60 wherein said positive composite electrode further comprises at least one protective additive.

64. The method recited in claim 60 wherein said negative composite electrode further comprises at least one protective additive.

65. The method recited in claim 60 wherein said impregnating act further comprises vacuum impregnating said electrodes with a protective additive.

66. The method recited in claim 60 further comprising the act of rolling said combination of said positive electrode, said porous separator, and said negative electrode into a spiral roll.

67. The method recited in claim 60 further comprising the acts of stacking said combination of said positive electrode, said porous separator, and said negative electrode.

68. The method recited in claim 60 further comprising the act of combining said porous separator, said negative electrode, and more than one said positive electrode into a stack of alternating positive and negative electrodes separated by said porous separator.

69. An electrochemical storage device made according to the method recited in claim 60.
